(19) United States
(12) Patent Application Publication
(10) Pub. No.: US 2016/0291373 A1
(43) Pub. Date: Oct. 6, 2016

(54) LIQUID CRYSTAL PANEL AND LIQUID CRYSTAL DISPLAY

(71) Applicant: NITTO DENKO CORPORATION, Osaka (JP)

(72) Inventor: Toshiyuki Iida, Ibaraki-shi (JP)

(73) Assignee: NITTO DENKO CORPORATION, Osaka (JP)

(21) Appl. No.: 15/076,943

(22) Filed: Mar. 22, 2016

(30) Foreign Application Priority Data
Mar. 31, 2015 (JP) 2015-073262

(51) Int. Cl. G02F 1/13363; G02F 1/1337; G02F 1/1335

(52) U.S. Cl. CPC G02F 1/13363; G02F 1/133528; G02F 1/1337; G02F 2001/133738; G02F 2001/133749; G02F 2001/133531

(57) ABSTRACT

The liquid crystal panel includes a liquid crystal cell, a first polarizer on one side of the liquid crystal cell, a second polarizer on the other side of the liquid crystal cell, a first optically anisotropic element having a positive refractive index anisotropy disposed between the liquid crystal cell and the first polarizer, and a second optically anisotropic element having a negative refractive index anisotropy disposed between the first optically anisotropic element and the liquid crystal cell. Liquid crystal molecule in the liquid crystal cell is homogeneously aligned and have a pretilt angle of 0.5° or less in non-electric-field state. At least one of the first optically anisotropic element and the second optically anisotropic element has a ratio R450/R550 of 1.1 or more, where R550 is a retardation at a wavelength of 550 nm and R450 is a retardation at a wavelength of 450 nm.

### BACKGROUND OF THE INVENTION

1. Technical Field

Disclosed is a liquid crystal panel including optically anisotropic elements between a liquid crystal cell and a polarizer. A liquid crystal display including the liquid crystal panel is also disclosed.

2. Description of Related Art

A liquid crystal panel includes a liquid crystal cell between a pair of polarizers. In an in-plane switching (IPS) mode liquid crystal cell, liquid crystal molecules are homogeneously aligned in a direction substantially parallel to a substrate surface in a non-electric-field state, and by application of an electric field in a horizontal direction, the liquid crystal molecules are rotated in a plane parallel to the substrate surface to control right transmission (white image display) and shielding (black image display). A liquid crystal panel including a liquid crystal cell with liquid crystal molecules homogeneously aligned in a non-electric-field state, e.g., an IPS mode liquid crystal panel, is excellent in viewing angle characteristics.

However, when an IPS mode liquid crystal panel is viewed from an oblique direction at an angle of 45 degrees (azimuth angle of 45 degrees, 135 degrees, 225 degrees or 315 degrees) with respect to the absorption axis of a polarizer, light leakage in black image display is significant, so that a color shift and a reduction in contrast easily occur. Accordingly a method has been proposed in which an optically anisotropic element (retarder) is disposed between a liquid crystal cell and a polarizer for the purpose of reducing a color shift and improving a contrast in an oblique viewing direction.

For example, JP 2005-208356 A describes a method for reducing black luminance and color shift of an IPS mode liquid crystal panel in an oblique direction with using optically anisotropic elements having positive refractive index anisotropy and negative refractive index anisotropy. Reduction of black luminance and color shift in a direction at azimuth angle of 45° and polar angle (angle with respect to the normal direction of a panel surface) of 60° is explained with using a Poincare sphere.

JP 2007-206605 A discloses that a color shift in an oblique direction in black image display in an IPS mode liquid crystal panel can be reduced by using a positive-A plate having a refractive index anisotropy of nx>ny=nz (positive refractive index anisotropy) and a positive-C plate having a refractive index anisotropy of nz>nx=ny (negative refractive index anisotropy). WO 2013/146633 discloses an optical compensation of an IPS mode liquid crystal panel using a stacked retarder. The stacked retarder includes an optical element having a positive refractive index anisotropy with using a liquid crystal material having a larger retardation at a longer wavelength (so called a reverse wavelength dispersion optical element), and an optical element having a negative refractive index anisotropy with using a thermoplastic resin material.

In a horizontal electric field type liquid crystal panel such as an IPS mode, one of the causes of viewing direction dependence of display image color is an influence of the pretilt of liquid crystal. For example, when liquid crystal molecules are aligned using a rubbed alignment film, the liquid crystal molecules have a pretilt angle of about 1 to 2°. Accordingly, when the direction (azimuth angle) of light transmitted through a liquid crystal cell varies, the apparent retardation of liquid crystal molecules changes to cause color change depending on the azimuth angle.

In recent years, horizontal electric field liquid crystal cells in which the pretilt angle of liquid crystal molecules is almost 0° (low tilt angle) have been developed by using a photo-alignment technique, and mass production thereof has been started. The use of a liquid crystal cell having a low tilt angle has made it possible to reduce color change associated with a change in azimuth angle. On the other hand, a slight difference in color over the whole panel has been more evidently recognized, as color change depending on the azimuth angle has been reduced to improve uniformity of color in every direction.

Generally, optical compensation of a liquid crystal panel is optimized for light with a wavelength near 550 nm (green light), which has a high spectral luminous efficiency. Accordingly, during black image display, light having a wavelength with a large deviation in optical design from the optimum value is leaked, so that the screen looks colored. In optical design, it is difficult to make the color in every viewing direction completely neutral, and therefore during black image display, the screen looks slightly colored according to the wavelength of light that is leaked. Since blue light (having a wavelength near 450 nm) has spectral luminous efficiency higher than red color (having a wavelength near 650 nm), the blue color tends to be favored as a color during black image display. However, according to studies conducted by the present inventors, it has been found that when a combination of optically anisotropic elements as described in JP 2007-206605 A and WO 2013/146633 is used for optical compensation of a horizontal electric field type liquid crystal panel with a low tilt angle, a black image display looks violet to red.

### SUMMARY OF THE INVENTION

In view of the above, the inventor has conducted studies on the color during black image display of a horizontal electric field type liquid crystal cell with a low tilt angle. It was resultantly found that by adjusting the wavelength dispersion of the retardation of an optically anisotropic element to fall within a specific range, a liquid crystal panel which has a small color shift associated with a change in viewing direction and exhibits a blue color during black image display is obtained.

The liquid crystal panel according to the present invention includes a liquid crystal cell, a first polarizer, a second polarizer; a first optically anisotropic element, and a second optically anisotropic element. The liquid crystal cell includes a liquid crystal layer containing liquid crystal molecules that are homogeneously aligned in a non-electric-field state. The first polarizer and the second polarizer are disposed on the first main surface side and the second main surface side of the liquid crystal cell, respectively. The first optically anisotropic element is disposed between the liquid crystal cell and the first polarizer. The second optically anisotropic element is disposed between the first optically anisotropic element and the liquid crystal cell. An absorption axis direction of the first polarizer and an absorption axis direction of the second polarizer are perpendicular to each other. In the liquid crystal cell, the pretilt angle of liquid crystal molecules in the non-electric-field state is 0.5° or less.

The first optically anisotropic element has a positive refractive index anisotropy, and the second optically anisotropic element has a negative refractive index anisotropy. At least one of the first optically anisotropic element and the second optically anisotropic element has the ratio R450/R550 of 1.1 or more, where R550 is retardation at a wavelength of 550 nm and R450 is retardation at a wavelength of 450 nm.

In the liquid crystal panel according to the present invention, it is preferable that the alignment direction of liquid crystal molecules in a non-electric-field state in the liquid crystal cell (initial alignment direction of liquid crystal) and the absorption axis direction of the first polarizer are perpendicular to each other.

The liquid crystal panel according to the present invention has a small color shift associated with a change in viewing direction, a color uniformity during black image display, and small color change, and is therefore excellent in visibility.

The present invention also relates to a liquid crystal display including a light source on the first main surface side (first polarizer side) or the second main surface side (second polarizer side) of the liquid crystal panel. The liquid crystal display is in E-mode when it includes a light source on the first main surface side. The liquid crystal display is in O-mode when it includes a light source on the second main surface side. The liquid crystal panel according to the present invention is applicable to both of E-mode and O-mode liquid crystal displays. The O-mode liquid crystal display with a light source disposed on the second main surface side exhibits a higher contrast and is excellent in visibility.

### BRIEF DESCRIPTION OF THE DRAWINGS

FIG. 1 is a schematic sectional view of a liquid crystal display according to one embodiment, of the present invention; and

FIGS. 2 to 4 are conceptual views each showing a configuration of optical elements in a liquid crystal panel according to an embodiment, of the present invention.

### DETAILED DESCRIPTION OF EMBODIMENTS

### Outline of Whole Liquid Crystal Panel

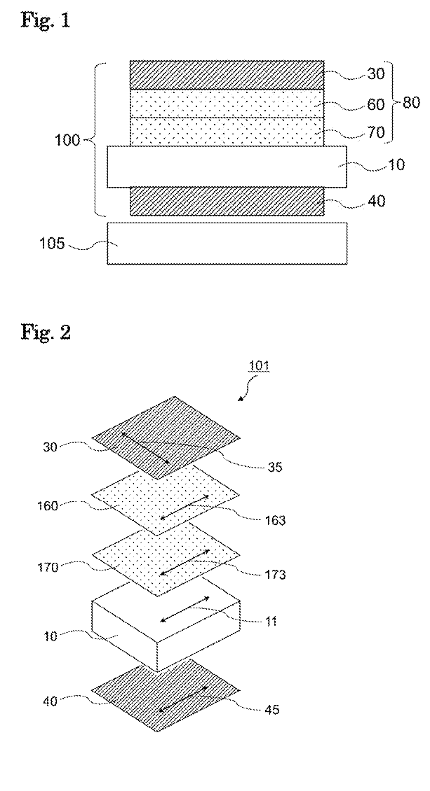

FIG. 1 is a schematic sectional view of a liquid crystal display including a liquid crystal panel 100 according to one embodiment. The liquid crystal panel 100 includes a liquid crystal cell 10 having a first main surface and a second main surface. A first polarizer 30 is disposed on the first main surface side of the liquid crystal cell 10, and a second polarizer 40 is disposed on the second main surface side of the liquid crystal cell 10. Between the liquid crystal cell 10 and the first polarizer 30, a first optically anisotropic element 60 and a second optically anisotropic element 70 are disposed in this order from the first polarizer 30 side. Specifically, the liquid crystal panel according to the present invention includes the first polarizer 30, the first optically anisotropic element 60, the second optically anisotropic element 70, the liquid crystal cell 10, and the second polarizer 40 in this order from the first main surface side.

[Liquid Crystal Cell]

The liquid crystal cell 10 includes a liquid crystal layer between a pair of substrates. In a general configuration, one substrate is provided with a color filter and a black matrix, and the other substrate is provided with a switching element and the like for controlling the electro-optical characteristics of liquid crystal.

The liquid crystal layer contains liquid crystal molecules that are homogeneously aligned in a non-electric-field state. An alignment direction 11 of liquid crystal molecules in a non-electric-field state is referred to as an “initial alignment direction”. The homogeneously aligned liquid crystal molecules are those in which the alignment vectors of liquid crystal molecules are aligned uniformly and parallel to a substrate surface. The alignment vectors of liquid crystal molecules slightly tilt to the substrate surface, and thus have a pretilt. The liquid crystal cell 10 to be used in the liquid crystal panel is a low-tilt cell having a pretilt angle of 0.5° or less. The pretilt angle of the liquid crystal cell 10 is preferably 0.3° or less. Since the pretilt angle of the liquid crystal cell is small, a liquid crystal panel which has a high contrast even when viewed in an oblique direction and which has small color change associated with a change in viewing azimuth angle is obtained.

Examples of the liquid crystal cell having homogeneously aligned liquid crystal molecules in non-electric-field state include in-plane switching (IPS) mode, fringe field switching (FFS) mode, ferroelectric liquid crystal (FLC) mode. As liquid crystal molecules, nematic liquid crystal, smectic liquid crystal, or the like is used. Generally, for the liquid crystal cells in IPS mode and FFS mode, nematic liquid crystal is used, and for the liquid crystal cell in FLC mode, smectic liquid crystal is used.

[Polarizer]

The first polarizer 30 is disposed in the first main surface side of the liquid crystal cell 10, and the second polarizer 40 is disposed on the second main surface side of the liquid crystal cell 10. The polarizer converts natural light and any polarized light into linearly polarized light. As the first polarizer 30 and the second polarizer 40 in the liquid crystal panel, any suitable polarizers can be employed according to a purpose. Examples of the polarizers include films obtained by uniaxially stretching a hydrophilic polymer film such as a polyvinyl alcohol-based film, a partially formulated polyvinyl alcohol-based film or an ethylene-vinyl acetate copolymer-based partially saponified film with a dichroic substance such as iodine or a dichroic dye adsorbed to the film, and polyene-based oriented films such as dehydrated products of poly vinyl alcohol and dehydrochlorinated products of polyvinyl chloride. Guest/host type polarizers obtained by unidirectionally orienting a liquid crystal composition including a dichroic substance and a liquid crystal compound as disclosed in U.S. Pat. No. 5,523,863, E type polarizers obtained by unidirectionally orienting lyotropic liquid crystal as disclosed in U.S. Pat. No. 6,049,428, and so on may also be used.

Among these polarizers, ones having high degree of polarization such as polyvinyl alcohol (PVA)-based polarizers are preferably used. PVA-based film may be a polyvinyl alcohol film or a partially formulated polyvinyl alcohol film. PVA-based polarizer is oriented PVA-based film with a dichroic substance such as iodine or a dichroic dye adsorbed thereinto. PVA-based polarizer can be obtained, for example, by iodine-dying and stretching a polyvinyl alcohol-based film.

As the PVA-based polarizer, a thin polarizer having a thickness of 10 μm or less may also be used. Examples of the thin polarizer include thin polarizers as described in JP 51-069644A, JP 2000-338329 A, WO 2010/100917, JP 4691205 B, JP 4751481 B, and so on. These thin polarizers are obtained by for example, a production method including the steps of stretching a laminate of PVA-based resin layer and a stretchable resin base material; and performing iodine dying to the PVA-based resin layer.

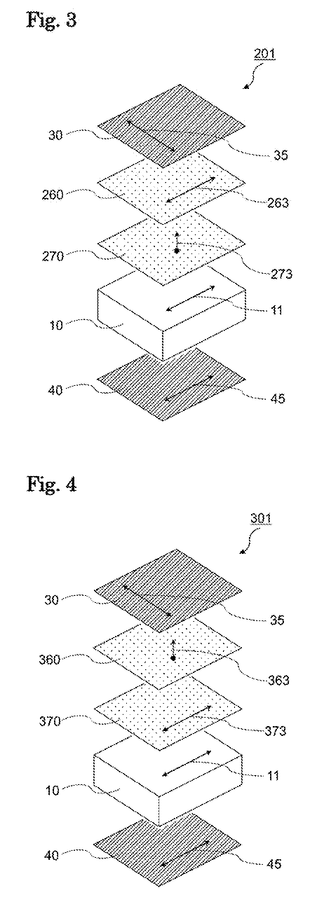

In the liquid crystal panel according to the present invention, the first polarizer 30 and the second polarizer 40 are disposed in such a manner that absorption axis directions 35 and 45 of both the polarizers are perpendicular to each other. The absorption axis direction 35 of the first polarizer 30 and the initial alignment direction 11 of the liquid crystal cell 10 are parallel or perpendicular to each other. Preferably, the absorption axis direction 35 of the first polarizer 30 and the initial alignment direction 11 of the liquid crystal cell 10 are perpendicular to each other as shown in FIGS. 2 to 4.

In this specification, the term “perpendicular” encompasses not only being completely perpendicular, but also being substantially perpendicular, and the angle thereof is generally within 90±2°, preferably within 90±1°, more preferably within 90±0.5°. Similarly, the term “parallel” encompasses not only being completely parallel, but also being substantially parallel, and the angle thereof is generally within ±2°, preferably ±1°, more preferably within ±0.5°.

[First Optically Anisotropic Element and Second Optically Anisotropic Element]

The liquid crystal panel according to the present invention includes, between the liquid crystal cell 10 and the first polarizer 30, the first optically anisotropic element 60 and the second optically anisotropic element 70 in this order from the first polarizer 30 side.

The first optically anisotropic element 60 has a positive refractive index anisotropy. The optically anisotropic element having a positive refractive index anisotropy satisfies the relationship of nx>nz and nx≧ny≧nz, where nx is a refractive index in the in-plane slow axis direction, ny is a refractive index in the in-plane fast axis direction, and nz is a refractive index in the thickness direction. Specific examples of the optically anisotropic element having a positive refractive index anisotropy include a positive-A plate (nx>ny=nz), a negative-B plate (nx>ny>nz) and a negative-C plate (nx=ny>nz).

As a material that forms the optical element having a positive refractive index anisotropy a polymer having a positive intrinsic birefringence is preferably used. The polymer having a positive intrinsic birefringence refers to a polymer in which the birefringence in the orientation direction becomes relatively large when a polymer is oriented by stretching etc. Examples of the polymer having a positive intrinsic birefringence include polycarbonate-based resins, polyester-based resins such as polyethylene terephthalate and polyethylene naphthalate, polyarylate-based resins, sulfone-based resins such as polysulfone and polyether sulfone, sulfide-based resins such as polyphenylene sulfide, polyimide-based resins, cyclic polyolefin-based (polynorbornene-based) resins, polyamide resins, polyolefin-based resins such as polyethylene and polypropylene, and cellulose esters. A liquid crystal material may be used as a material having a positive intrinsic birefringence.

The second optically anisotropic element 70 has a negative refractive index anisotropy. The optically anisotropic element having a negative refractive index anisotropy satisfies the relationship of nz>ny and nz≧nx≧ny, where nx is a refractive index in the in-plane slow axis direction, ny is a refractive index in the in-plane fast axis direction, and nz is a refractive index in the thickness direction. Specific examples of the optically anisotropic element having a negative refractive index anisotropy include a negative-A plate (nz=nm>ny), a positive-B plate (nz>nx>ny) and a positive-C plate (nz>nx=ny).

As a material that forms the optical element having a negative refractive index anisotropy, a polymer having a negative intrinsic birefringence is preferably used. The polymer having a negative intrinsic birefringence refers to a polymer in which the birefringence in the orientation direction becomes relatively small when a polymer is oriented by stretching etc. The polymer having a negative intrinsic birefringence is, for example, a polymer including a chemical bond or functional group having large polarization anisotropy, such as an aromatic or carbonyl group, on polymer side chain. Specific examples of the negative birefringence polymer include acryl-based resins, styrene-based resins, maleimide-based resins and fumaric acid ester-based resins. A liquid crystal material may be used as a material having a negative intrinsic birefringence. For example, a negative-A plate is obtained by orienting discotic liquid crystal vertically to the film surface. A positive-C plate is obtained by homeotropically orienting a liquid crystal compound on a film.

For the description of “ny=nz” in the positive-A plate or the description of “nz=ny” in the negative-A plate in this specification, the refractive index (nx or ny) in the plane and the refractive index nz in the thickness direction are not necessarily required to be completely equal to each other. The optically anisotropic element can be considered as a positive-A plate with nx=ny when the Nz coefficient expressed by Nz=(nx−nz)(nx−ny) is in the range of 0.97 to 1.03, and the optically anisotropic element can be considered as a negative-A plate with nz=ny when the Nz coefficient is in the range of −0.03 to 0.03. Similarly; for the description of “nx=ny” in the negative-C plate and the positive-C plate, the refractive index (rx) in the slow axis direction and the refractive index (ny) in the fast axis direction in the plane are not necessarily required to be completely equal to each other, and the optically anisotropic element, can be considered as a C plate with nx=ny when the Nz coefficient is 20 or more or −20 or less. In this specification, the refractive index and the retardation are values at a wavelength of 550 nm.

When a polymer material is used, optically anisotropic element (retardation film) can be formed by stretching a polymer film to enhance the molecular orientation in a specific direction. Examples of the method for stretching a polymer film include a longitudinal uniaxial stretching method, a lateral uniaxial stretching method, a longitudinal and lateral sequential biaxial stretching method and a longitudinal and lateral simultaneous biaxial stretching method. Any suitable stretching machine such as a roll stretching machine, a tenter stretching machine, or a pantograph-type or a linear motor-type biaxial stretching machine can be used for stretching the film.

When a liquid crystal material is used as a material of the optically anisotropic element, the liquid crystal material (liquid crystal monomer and/or liquid crystal polymer) is applied onto a base material, and polymerization of the liquid crystal monomer, orientation of the liquid crystal material, removal of the solvent (drying) and so on are performed as necessary to form a liquid crystal layer, whereby an optically anisotropic element is obtained. As the liquid crystal monomer, a liquid crystal compound having at least one unsaturated double bond such as an acryloyl group, a methacryloyl group or a vinyl group, or at least one polymerizable functional group such as an epoxy group at the end and showing an orientation property such as a nematic or smectic orientation is used. The liquid crystal material containing a liquid crystal monomer may include a polymerization initiator in addition to the liquid crystal monomer. Examples of the method for polymerizing a polymerizable liquid crystal monomer include thermal polymerization and ultraviolet polymerization, and an appropriate polymerization initiator is used according to a polymerization method. As the liquid crystal polymer, a main chain type liquid crystal polymer or a side chain type liquid crystal polymer each showing a liquid crystal orientation such as a nematic or smectic liquid crystal orientation, or a liquid crystal compound composed of a combination of these liquid crystal polymers is used. The molecular weight of the liquid crystal polymer is not particularly limited, and is preferably about 2000 to 100000 in terms of a weight average molecular weight.

A base material with a liquid crystal layer formed thereon may be directly used as an optically anisotropic element. For example, a liquid crystal layer having a negative refractive index anisotropy, such as discotic liquid crystal layer, is formed as the second optically anisotropic element on the first optically anisotropic element having a positive refractive index anisotropy to obtain a laminated optically anisotropic element in which the first optically anisotropic element and the second optically anisotropic element are integrally laminated. A laminated optically anisotropic element can also be obtained by transferring a liquid crystal layer (optically anisotropic element) formed on a base material onto other optically anisotropic element.

The thickness d₁ of the first optically anisotropic element and the thickness d₂ of the second optically anisotropic element can be each appropriately selected according to a material that forms the optically anisotropic element, etc. When a polymer material is used, the thickness of each optically anisotropic element is generally about, 3 μm to 200 μm. When a liquid crystal material is used, the thickness of each optically anisotropic element (thickness of the liquid crystal layer) is generally about 0.1 μm to 20 μm.

In at least any one of the first optically anisotropic element 60 and the second optically anisotropic element 70, R450/R550 is 1.1 or more. R450/R550 is a ratio of the retardation R550 at a wavelength of 550 nm and the retardation R450 at a wavelength of 450 nm (hereinafter, sometimes referred to as a “wavelength dispersion”). In the A plate and B plate, the wavelength dispersion R450/R550 is determined from the ratio of in-plane retardations at a wavelength of 450 nm and a wavelength of 550 nm. In the C plate, the wavelength dispersion R450/R550 is determined from the oblique-direction retardation measured in a direction inclined by 40° with respect to the normal line of the film surface.

When the wavelength dispersion R450/R550 of the first optically anisotropic element is 1.1 or more, a polyarylate-based resin, a sulfone-based resin, a sulfide-based resin, a polyimide-based resin, a polyamide-based resin or the like is preferably used as a material of the first optically anisotropic element. When the wavelength dispersion R450/R550 of the second optically anisotropic element is 1.1 or more, an acryl-based polymer including an aromatic ring on the side chain, or the like is preferably used as a material of the second optically anisotropic element. The wavelength dispersion of the retardation can also be adjusted by, for example, a method in which nanoparticles of a metal or metal oxide are dispersed in a polymer material.

When an optically anisotropic element having a large wavelength dispersion R450/R550 is used as the first optically anisotropic element and/or the second optically anisotropic element, the color during black image display in a liquid crystal panel with a low-tilt cell can be made uniformly blue in every direction, so that a color shift decreases. As described above, optical compensation of the liquid crystal panel is optimized for green light with a wavelength near 550 nm. When an optically anisotropic element having a large wavelength dispersion R450/R550 is used, green light is properly optically compensated so that light leakage does not occur, whereas on the short wavelength (blue) side, the retardation of the optically anisotropic element is larger than the optimum retardation for preventing occurrence of light leakage. Therefore short wavelength light leaks, and as a result, black image display is colored blue. In the present invention, leakage of light on the short wavelength side during black image display is made relatively large by increasing the wavelength dispersion R450/R550 of the retardation of the optically anisotropic element, a blue color is retained even when the viewing angle (azimuth angle) is changed.

When one of the first optically anisotropic element and the second optically anisotropic element has the wavelength dispersion R450/R550 of 1.1 or more, the other optically anisotropic element may have the wavelength dispersion R450/R550 less than 1.1. It is preferable that both the first optically anisotropic element and the second optically anisotropic element have a wavelength dispersion R450/R550 of 1.1 or more so that the color shift tends to be further reduced.

The upper limit of the wavelength dispersion R450/R550 of the first optically anisotropic element and the second optically anisotropic element is not particularly limited. When the wavelength dispersion R450/R550 is excessively larger, blue light leakage during black image display increases, or the screen tends to be colored during white image display. Accordingly, the wavelength dispersion R450/R550 is preferably 1.3 or less, more preferably 1.25 or less, further preferably 1.2 or less.

A difference between the wavelength dispersion R450R550 of the first optically anisotropic element and the wavelength dispersion R450/R550 of the second optically anisotropic element is preferably 0.1 or less, more preferably 0.08 or less, further preferably 0.06 or less. When the wavelength dispersions of the first optically anisotropic element and the second optically anisotropic element are close to each other, the color shift tends to decrease. This is because viewing direction dependence of retardation wavelength dispersion in laminated optical element, in which a laminate of both the optically anisotropic elements is considered as one optical element, is small.

[Combination of First Optically Anisotropic Element and Second Optically Anisotropic Element]

When the first optically anisotropic element is a positive-A plate having a refractive index anisotropy of nx>ny=nz, a positive-B plate having a refractive index anisotropy of nz>nx>ny or a positive-C plate having a refractive index anisotropy of nz>nx=ny is preferably used as the second optically anisotropic element. In particular, when the second optically anisotropic element is a positive-C plate, the color at every azimuth angle in an oblique direction is easily adjusted to blue.

When the first optically anisotropic element is a negative-B plate having a refractive index anisotropy of nx>ny>nz, the second optically anisotropic element may be any of a negative-A plate having a refractive index anisotropy of nz=nx>ny a positive-B plate having a refractive index anisotropy of nz>nx>ny and a positive-C plate having a refractive index anisotropy of nz>nx=ny. In particular; the second optically anisotropic element is preferably a negative-A plate of a positive-C plate, and when the second optically anisotropic element is a positive-C plate, the color at every azimuth is easily adjusted to blue.

When the first optically anisotropic element is a negative-C plate having a refractive index anisotropy of nx=ny>nz, a negative-A plate having a refractive index anisotropy of nz=nx>ny or a positive-B plate having a refractive index anisotropy of nz>nx>ny is preferably used as the second optically anisotropic element. In particular, when the second optically anisotropic element, is a positive-A plate, the color at every azimuth angle is easily adjusted to blue.

The axis direction of each of the first optically anisotropic element 60 and the second optically anisotropic element 70 disposed between the liquid crystal cell 10 and the first polarizer 30 is not particularly limited. When the optically anisotropic element is an A plate or a B plate, it is preferable that each optically anisotropic element is disposed in such a manner that the slow axis direction is parallel or perpendicular to the initial alignment direction 11 of the liquid crystal cell 10, and it is particularly preferable that each optically anisotropic element is disposed in such a manner that the slow axis direction of the optically anisotropic element is parallel to the initial alignment direction 11 of the liquid crystal cell 10.

FIGS. 2 to 4 are a conceptual views each showing the configuration of optical elements in a preferred embodiment of the liquid crystal panel. The arrows in FIGS. 2 to 4 each show the optical axis direction of the optically anisotropic element (the arrow 363 in FIG. 4 shows a fast axis direction, and the other directions each show a slow axis direction).

When the first optically anisotropic element 160 is a positive-A plate or a negative-B plate, and the second optically anisotropic element 170 is a negative-A plate or a positive-B plate, it is preferable that as shown in FIG. 2, the slow axis direction 163 of the first optically anisotropic element and the slow axis direction 173 of the second optically anisotropic element are both parallel to the initial alignment direction 11 of the liquid crystal cell 10, and perpendicular to the absorption axis direction 35 of the first polarizer 30.

When the first optically anisotropic element 260 is a positive-A plate or a negative-B plate, and the second optically anisotropic element 270 is a positive-C plate, it is preferable that as shown in FIG. 3, the slow axis direction 263 of the first optically anisotropic element is parallel to the initial alignment direction 11 of the liquid crystal cell 10, and perpendicular to the absorption axis direction 35 of the first polarizer 30.

When the first optically anisotropic element 360 is a negative-C plate, and the second optically anisotropic element 370 is a negative-A plate or a positive-B plate, it is preferable that as shown in FIG. 4, the slow axis direction 373 of the second optically anisotropic element is parallel to the initial alignment direction 11 of the liquid crystal cell 10, and perpendicular to the absorption axis direction 35 of the first polarizer 30.

The retardation of each of the first optically anisotropic element and the second optically anisotropic element, is not particularly limited, and the in-plane retardation Re and the thickness-direction retardation Rth may be adjusted so that light leakage at a wavelength of 550 nm in an oblique direction during black image display can be reduced. As described above, the optically anisotropic element has a large retardation wavelength dispersion R450/R550, and therefore leakage of a short wavelength blue light may occur during black image display. The contrast, on the other hand, can be kept high when leakage of green light having high spectral luminous efficiency is small.

When the slow axis direction of each of the first optically anisotropic element and the second optically anisotropic element is parallel to the initial alignment direction of the liquid crystal cell as shown in FIGS. 2 to 4, the sum of the in-plane retardation Re₁ of the first optically anisotropic element and the in-plane retardation Re₂ of the second optically anisotropic element (Re₁+Re₂) is preferably 90 to 120 m, more preferably 100 to 170 nm. The sum of the thickness-direction retardation Rth₁ of the first optically anisotropic element and the thickness-direction retardation Rth₂ of the second optically anisotropic element (Rth₁+Rth₂) is preferably 30 nm to 100 nm, more preferably 40 nm to 80 nm. The ratio (Rth₁+Rth₂)(Re₁+Re₂) is preferably 0.2 to 0.8, more preferably 0.3 to 0.7.

By ensuring that the optical anisotropy of each of the first optically anisotropic element and the second optically anisotropic element, which are disposed between the liquid crystal cell 10 and the polarizer 30, is in the above-mentioned range, the black luminance in an oblique direction, particularly at an angle of 45 degrees (azimuth angle of 45 degrees, 135 degrees, 225 degrees or 315 degrees) with respect to the absorption axis of the polarizer can be reduced to enhance the contrast.

The first optically anisotropic element and the second optically anisotropic element have a refractive index nx₁ and a refractive index nx₂ in the in-plane slow axis direction; a refractive index ny₁ and a refractive index ny₂ in the in-plane fast axis direction; a refractive index nz₁ and a refractive index nz₂ in the thickness direction; and a thickness d₁ and a thickness d₂, respectively. In-plane retardations Re₁ and Re₂ and thickness-direction retardations Rth₁ and Rth₂ are defined as follows.

Re₁=(nx₁−ny₁)×d₁;

Rth₁=(nx₁−nz₁)×d₁;

Re₂=(nx₂−ny₂)×d₂; and

Rth₂=(nx₂−nz₂)×d₂.

[Configuration of Optical Members]

The liquid crystal panel according to the present invention can be prepared by disposing the second optically anisotropic element 70, the first optically anisotropic element 60 and the first polarizer 30 on the first main surface side of the liquid crystal cell 10, and disposing the second polarizer 40 on the second main surface side of the liquid crystal cell 10.

An optically isotropic film as a polarizer protective film may also be provided between the first polarizer 30 and the first optically anisotropic element 60 or between the second polarizer 40 and the liquid crystal cell 10. By providing a polarizer protective film on a surface of the polarizer, durability of the polarizer can be enhanced. The optically isotropic film to be used as a polarizer protective film is one that does not substantially change the polarized state of light which transmits in any of the normal direction and the oblique direction. Specifically, the optically isotropic film has an in-plane retardation Re of preferably 10 nm or less and a thickness-direction retardation Rth of preferably 20 nm or less. The in-plane retardation of the optically isotropic film is more preferably 5 nm or less. The thickness-direction retardation of the optically isotropic film is more preferably 10 nm or less, further preferably 5 nm or less.

The liquid crystal panel according to the present invention may include an optical layer other than that described above, and other members. For example, it is preferable to provide a polarizer protective film on the outer surface (surface that does not face the liquid crystal cell 10) of each of the first polarizer 30 and the second polarizer 40. The polarizer protective film to be provided on the outer surface of the polarizer may be optically isotropic, or may be optically anisotropic. The polarizer protective film to be provided on a surface of the first polarizer 30 on the liquid crystal cell 10 side and the polarizer protective film to be provided on the liquid crystal cell 10 side of the second polarizer 40 are required to be optically isotropic as described above. Preferably; the liquid crystal panel according to the present invention does not include an optical anisotropic element other than the first optically anisotropic element and the second optically anisotropic element between the first polarizer 30 and the liquid crystal cell 10, and does not include an optically anisotropic element between the second polarizer 40 and the liquid crystal cell 10.

The liquid crystal cell and the above-mentioned optical members are laminated to form a liquid crystal panel. In fabrication process of the liquid crystal panel, the members may be sequentially and separately laminated on the liquid crystal cell, or a laminated film obtained by laminating some members beforehand may be used. The order of laminating these optical members is not particularly limited. Preferably, the first polarizer 30, the first optically anisotropic element 60 and the second optically anisotropic element 70 are laminated to form a laminated polarizing plate 80 beforehand, and the laminated polarizing plate 80 is bonded to the liquid crystal cell 10 with a pressure sensitive adhesive (not illustrated) interposed therebetween. As described above, an optically isotropic film as a polarizer protective film may be provided between the first polarizer 30 and the first optically anisotropic element 60.

An adhesive or a pressure sensitive adhesive is preferably used for laminating the members. As the adhesive or pressure sensitive adhesive, one having as a base polymer an acryl-based polymer, a silicone-based polymer, polyester, polyurethane, polyamide, polyvinyl ether, a vinyl acetate/vinyl chloride copolymer, a modified polyolefin, an epoxy-based polymer, a fluorine-based polymer, a rubber-based polymer or the like can be appropriately selected and used.

[Liquid Crystal Display]

A liquid crystal display is formed by arranging a light source on the first main surface side (first polarizer 30 side) or the second main surface side (second polarizer 40 side) of the liquid crystal panel. When a light source is arranged on the first main surface side, the absorption axis direction 35 of the polarizer on the light source side (first polarizer 30) and the initial alignment direction 11 of the liquid crystal cell 10 are perpendicular to each other, and therefore the liquid crystal display is in E-mode. As shown in FIG. 1, when a light source 105 is arranged on the second main surface side, the absorption axis direction 45 of the polarizer on the light source side (second polarizer 40) and the initial alignment direction 11 of the liquid crystal cell 10 are parallel to each other, and therefore the liquid crystal display is in O-mode.

A liquid crystal panel 100 according to the present invention can be used in either of E-mode and O-mode. In O-mode, the contrast tends to be further enhanced because linearly polarized light transmitting through the second polarizer 40 is directly incident to the liquid crystal cell 10 without being affected by the optically anisotropic element.

A brightness enhancement film (not illustrated) may also be provided between the liquid crystal panel and the light source. The brightness enhancement film may be laminated with the polarizer on the light source side. For example, in the O-mode liquid crystal display a brightness enhancement film may be bonded to the outer surface of the second polarizer on the light source side with an adhesive layer interposed therebetween. A polarizer protective firm may be provided between the polarizer and the brightness enhancement film.

### EXAMPLES

Hereinafter, the present invention will be described in detail by showing comparison between Examples and Comparative Examples, but the present invention is not limited to these examples.

### Example 1

Simulation was conducted using as a simulation model an O-mode liquid crystal display including a polarizer, an IPS liquid crystal cell (in-plane retardation: 322 nm; pretilt angle: 0.1°), a second optically anisotropic element (negative-A plate having a refractive index anisotropy of nx=nz>ny and in-plane retardation Re₂ of 120 nm), a first optically anisotropic element (negative-C plate having a refractive index anisotropy of nx=ny>nz and thickness-direction retardation Rth₁ of 80 nm), and a polarizer in this order from the light source side. Each of the wavelength dispersions of the retardations of the first optically anisotropic element and the second optically anisotropic element was R450/R550=1.10. The configuration of the optically anisotropic elements was as shown in FIG. 4.

For simulation, a liquid crystal display device simulator “LCD MASTER Ver. 6.084” manufactured by SHINTECH, INC was used. The extension function of LCD Master was used to determine the contrast and the chromaticity x, y in the XYZ color system dining black image display in each viewing direction (polar angle θ=0 to 80°, azimuth angle φ=0 to 360°).

### Comparative Example 1

Simulation was conducted in the same manner as in Example 1 except that the pretilt angle of the liquid crystal cell was changed to 2°.

### Comparative Example 2

Simulation was conducted under the same conditions as in Comparative Example 1 except that the wavelength dispersion R450/R550 of the retardation of each of the first optically anisotropic element and the second optically anisotropic element was changed to 1.02.

Table 1 shows contrast maps, and tracks on the x, y chromaticity diagram (CIE chromaticity diagram) with the azimuth angle changed at a polar angle of 60° in Example 1 and Comparative examples 1 and 2. In Tables 1 to 7, the values of the in-plane retardation Re, the thickness-direction retardation Rth, and the wavelength dispersion R450/R550 are shown in the upper column for the first optically anisotropic element, and shown in the lower column for the second optically anisotropic element.

It is apparent that in Example 1 where the pretilt angle of the liquid crystal cell is small and the wavelength dispersion R450/R550 of the optically anisotropic element is large, tracks on the chromaticity diagram are distributed on a straight line extending toward a point near a wavelength 450 nm on a spectral track from a coordinate (x, y)=(0.33, 0.33) representing a neutral color, and has a blue color irrespective of the viewing azimuth angle. It is apparent that on the other hand, in Comparative Examples 1 and 2 where a liquid crystal cell having a pretilt of 2° is used, a region surrounded by tracks on the chromaticity diagram extends, and irrespective of the value of the wavelength dispersion R450/R550 of the optically anisotropic element, uniformity of the color is low, and the color shift is large. From these results, it is apparent that by ensuring that the wavelength dispersion of the retardation of the optically anisotropic element is in a specific range when the liquid crystal cell has a small pretilt angle, the color can be made uniformly blue even when the vie wing azimuth angle is changed.

### Examples 2 to 4 and Comparative Example 3

Simulation was conducted in the same manner as in Example 1 except that a liquid crystal cell having a pretilt angle of 0° was used, the thickness-direction retardation Rth₁ of the first optically anisotropic element was changed to 60 nm, and the wavelength dispersion R450,R550 of the retardation of each of the first optically anisotropic element and the second optically anisotropic element was changed. The results are shown in Table 2.

From the results in Table 2, it is apparent that as long as the value of the retardation of the optically anisotropic element at a wavelength of 550 nm is unchanged, there is no significant change in contrast even when the wavelength dispersion varies. It is apparent that in Comparative Example 3 where the wavelength dispersion of the retardation of each of the first optically anisotropic element and the second optically anisotropic element is R450/R550=1.02, the area of a region surrounded by tracks on the chromaticity diagram is wide, and thus the color shift is large. In Comparative Example 3, tracks protrude to the red region (i.e., black image display looks reddish depending on the viewing direction).

It is apparent that on the other hand, in Examples 2 to 4 where at least any one of the first optically anisotropic element and the second optically anisotropic element has a wavelength dispersion R450/R550 of 1.10 or more, the area of a region surrounded by tracks on the chromaticity diagram is smaller, and thus the color shift is smaller as compared to Comparative Example 3, and in addition, tracks do not protrude to the red region, and thus a blue color is retained even when the viewing direction is changed.

### Examples 5 to 7 and Comparative Example 4

Simulation was conducted in the same manner as in Example 1. A liquid crystal cell having a pretilt angle of 0°, negative-C plate having a refractive index anisotropy of nx=ny>nz as a first optically anisotropic element, and positive-B plate having a refractive index anisotropy of nz>nx>ny as a second optically anisotropic element were used, and the wavelength dispersion R450/R550 of the retardation of each of the first optically anisotropic element and the second optically anisotropic element was changed. Optical properties of the optically anisotropic elements used in the simulation and the simulation results are shown in Table 3.

### Examples 8 and 9 and Comparative Examples 5 and 6

Simulation was conducted in the same manner as in Example 1. A liquid crystal cell having a pretilt angle of 0°, negative-B plate having a refractive index anisotropy of nx>ny>nz as a first optically anisotropic element, and positive-C plate having a refractive index anisotropy of nz>mx=ny as a second optically anisotropic element were used, and the wavelength dispersion R450/R550 of the retardation of each of the first optically anisotropic element and the second optically anisotropic element was changed. Optical properties of the optically anisotropic elements used in the simulation and the simulation results are shown in Table 4.

### Examples 10 to 12 and Comparative Example 7

Simulation was conducted in the same manner as in Example 1. A liquid crystal cell having a pretilt angle of 0°, negative-B plate having a refractive index anisotropy of nx>ny>nz as a first optically anisotropic element, and negative-A plate having a refractive index anisotropy of nx=nz>ny as a second optically anisotropic element were used, and the wavelength dispersion R450/R550 of the retardation of each of the first optically anisotropic element and the second optically anisotropic element was changed. Optical properties of the optically anisotropic elements used in the simulation and the simulation results are shown in Table 5.

### Examples 13 to 15 and Comparative Example 8

Simulation was conducted in the same manner as min Example 1. A liquid crystal cell having a pretilt angle of 0°, positive-A plate having a refractive index anisotropy of nx>ny=nz as a first optically amsotropic element, and positive-C plate having a refractive index anisotropy of nz>nx=ny as a second optically anisotropic element were used, and the wavelength dispersion R450/R550 of the retardation of each of the first optically anisotropic element and the second optically anisotropic element was changed. Optical properties of the optically anisotropic elements used in the simulation and the simulation results are shown in Table 6.

### Examples 16 to 18 and Comparative Example 9

Simulation was conducted in the same manner as in Example 1. A liquid crystal cell having a pretilt angle of 0°, positive-A plate having a refractive index anisotropy of nx>ny=nz as a first optically anisotropie element, and positive-B plate having a refractive index anisotropy of nz>nx>ny as a second optically anisotropic element were used, and the wavelength dispersion R450/R550 of the retardation of each of the fast optically anisotropic element and the second optically anisotropic element was changed. Optical properties of the optically anisotropic elements used in the simulation and the simulation results are shown in Table 7.

From the above results, it is apparent that when the pretilt angle of the liquid crystal cell is small, a liquid crystal panel, which has a small color shift and retains a blue color even when the viewing direction is changed, can be obtained by ensuring that the wavelength dispersion R450/R550 of the retardation of at least one of the first optically anisotropic element and the second optically anisotropic element is 1.10 or more. Any of a combination of a negative-C plate and a negative-A plate (Table 2), a combination of a negative-C plate and a positive-B plate (Table 3), a combination of a negative-B plate and a positive-C plate (Table 4), a combination of a negative-B plate and a negative-A plate (Table 5), a combination of a positive-A plate and a positive-C plate (Table 6) and a combination of a positive-A plate and a positive-B plate (Table 7) can be used as a combination of the first optically anisotropic element and the second optically anisotropic element for obtaining a liquid crystal panel with reduced color shift.

What is claimed is:

1. A Liquid crystal panel comprising:
a liquid crystal cell including a liquid crystal layer containing liquid crystal molecules that are homogeneously aligned in a non-electric-field state;
a first polarizer disposed on a first main surface side of the liquid crystal cell;
a second polarizer disposed on a second main surface side of the liquid crystal cell;
a first optically anisotropic element disposed between the liquid crystal cell and the first polarizer; and
a second optically anisotropic element disposed between the first optically anisotropic element and the liquid crystal cell, wherein
the liquid crystal molecule in the liquid crystal cell has a pretilt angle of 0.5° or less in non-electric-field state,
the first polarizer has an absorption axis direction perpendicular to an absorption axis direction of the second polarizer,
the first optically anisotropic element has a positive refractive index anisotropy,
the second optically anisotropic element has a negative refractive index anisotropy, and
at least one of the first optically anisotropic element and the second optically anisotropic element has a ratio R450/R550 of 1.1 or more, where R550 is a retardation at a wavelength of 550 nm and R450 is a retardation at a wavelength of 450 nm.

2. The liquid crystal panel according to claim 1, wherein a difference between the ratio R450/R550 of the first optically anisotropic element and the ratio R450/R550 of the second optically anisotropic element, is 0.1 or less

3. The liquid crystal panel according to claim 1, wherein both the first optically anisotropic element and the second optically anisotropic element have the ratio R450/R550 of 1.1 or more

4. The liquid crystal panel according to claim 1, wherein the first optically anisotropic element has a reactive index anisotropy of nx>ny≧nz

5. The liquid crystal panel according to claim 1, wherein the first optically anisotropic element has a refractive index anisotropy of nx=ny>nz, and the second optically anisotropic element has a refractive index anisotropy of nz≧nx>ny.

6. The liquid crystal panel according to claim 1, wherein an alignment direction of the liquid crystal molecules in a non-electric-field state in the liquid crystal cell and the absorption axis direction of the first polarizer are perpendicular to each other.

7. A liquid crystal display device comprising: the liquid crystal panel according to claim 1; and a light source on the first main surface side or the second main surface side of the liquid crystal panel.
